(19) United States
(12) Patent Application Publication
(10) Pub. No.: US 2024/0127009 A1
(43) Pub. Date: Apr. 18, 2024

(54) IN-MEMORY COMPUTING FOR APPROXIMATING KERNEL FUNCTIONS

(71) Applicant: International Business Machines Corporation, Armonk, NY (US)

(72) Inventors: Julian Röttger Büchel, Zurich (CH); Abbas Rahimi, Zurich (CH); Manuel Le Gallo-Bourdeau, Horgen (CH); Irem Boybat Kara, Adliswil (CH); Abu Sebastian, Adliswil (CH)

(21) Appl. No.: 17/957,286

(22) Filed: Sep. 30, 2022

(51) Int. Cl. G06J 1/00

(52) U.S. Cl. CPC G06J 1/00

(57) ABSTRACT

A probability distribution corresponding to the kernel function is determined and weights are sampled from the determined probability distribution corresponding to the given kernel function. Memristive devices of an analog crossbar are programmed based on the sampled weights, where each memristive device of the analog crossbar is configured to represent a corresponding weight. Two matrix-vector multiplication operations are performed on an analog input x and an analog input y using the programmed crossbar and a dot product is computed on results of the matrix-vector multiplication operations.

### BACKGROUND

The present invention relates generally to the electrical, electronic and computer arts and, more particularly, to in-memory computing (IMC) systems.

In machine learning, a “kernel” is usually used to refer to the kernel trick, a method of using a linear classifier to solve a non-linear problem. More specifically, the kernel itself is usually a similarity function between two inputs, while the kernel method is used to refer to the process of performing linear classification in order to solve a nonlinear task. Kernel functions are widely used in various machine learning models, ranging from simple Support Vector Machines (SVM) to complex deep learning architectures, such as conventional neural network architectures. In order to speed up computation, the kernel functions can be approximated using a random projection, where the vectors of the random projection are drawn from a kernel-specific distribution.

Traditional von Neumann architectures separate the memory and processor units. IMC employs a non-von Neumann architecture which addresses the performance and power bottlenecks caused by the movement of data between the processor and the main memory in traditional von Neumann architectures.

### BRIEF SUMMARY

Principles of the invention provide in-memory computing for approximating kernel functions. In one aspect, an exemplary method includes the operations of determining, using a digital processing unit, a probability distribution corresponding to the kernel function; sampling, using the digital processing unit, weights from the determined probability distribution corresponding to the given kernel function; programming, using a digital processing unit, memristive devices of an analog crossbar based on the sampled weights, where each memristive device of the analog crossbar is configured to represent a corresponding weight; performing two matrix-vector multiplication operations on a first analog input and a second analog input using the programmed crossbar; and computing, using the digital processing unit, a dot product on results of the matrix-vector multiplication operations.

In one aspect, a method for approximating a kernel function comprises determining, using a digital processing unit, a probability distribution corresponding to the kernel function; sampling, using the digital processing unit, weights from the determined probability distribution corresponding to the given kernel function; programming, using the digital processing unit, memristive devices of an analog crossbar based on the sampled weights, where each memristive device in the analog crossbar is configured to represent a corresponding weight; determining, using the digital processing unit, the programmed weights of the analog crossbar; calculating, using the digital processing unit, a column-wise standard deviation of the determined programmed weights using digital processing; storing the calculated row-wise standard deviation in a digital processing unit; and correcting, using the digital processing unit, the standard deviation of rows of the analog crossbar using the calculated row-wise standard deviation.

In one aspect, a method for approximating a kernel function comprises, for all weights programmed in an analog crossbar, selecting a device corresponding to one of a negative weight and a positive weight and setting the selected device to zero; for each device not set to zero, applying a plurality of low-amplitude pulses to set a conductance of the corresponding device to a high conductance; and, for each device not set to zero, applying one or more pulses with high-amplitude to decrease the conductance of the corresponding device.

In one aspect, a method for correcting row-wise standard deviation comprises programming, using a digital processing unit, a plurality of devices in an analog crossbar; applying a constant voltage across all rows in the analog crossbar, where each row comprises a device corresponding to a negative weight or a device corresponding to a positive weight; reading, using the digital processing unit, a value via a plurality of analog-to-digital converters; calculating, using the digital processing unit, an L1 norm of a standard Gaussian; and correcting, using the digital processing unit, the row-wise standard deviation by dividing the L1 norm of the standard Gaussian by the read value.

In one aspect, a method for processing an arc-cosine kernel comprises determining, using a digital processing unit, a probability distribution corresponding to an arc-cosine kernel function; sampling, using the digital processing unit, weights from the determined probability distribution corresponding to the arc-cosine kernel function; programming, using the digital processing unit, a plurality of devices of an analog crossbar based on the sampled weights, where each device in the analog crossbar is configured to represent a corresponding weight; performing a matrix-vector multiplication operation using the programmed crossbar array; pre-processing elements of outputs of the matrix-vector multiplication operation; and computing, using the digital processing unit, a dot product on the pre-processed elements of the outputs of the matrix-vector multiplication operation.

In another aspect, an exemplary apparatus includes a programming circuit; an analog crossbar array, coupled to the programming circuit, and having an input and an output; a digital to analog converter coupled to the input of the analog crossbar array; an analog to digital converter coupled to the output of the analog crossbar array; and a digital processing unit coupled to the analog to digital converter. The programming circuit is configured to program weights into the analog crossbar array; the analog crossbar array is configured to perform two matrix vector multiplications with first and second analog inputs obtained from the digital to analog converter, based on the programmed weights; and the digital processing unit is configured to computer a dot product of the outputs of the two matrix vector multiplications corresponding to the first and second inputs, obtained from the analog to digital converter.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
in-memory computing architecture and techniques for approximating kernel functions;
improved speed and improved energy efficiency provided by using IMC instead of digital processing units, such as central processing units (CPUs), graphics processing unit (GPUs), and the like, to approximate the kernel functions;
improve the technological process of computerized machine learning (e.g., speeding up the machine learning by approximating kernels using in-memory computation);
a crossbar architecture for performing multiply-accumulate (MAC) operations (performed using Kirchhoff's current laws); and
performance of matrix-vector multiply (MVM) operations in [symbol] (1) vs. performing MVM in digital with the complexity of a conventional MVM algorithm.

Some embodiments may not have these potential advantages and these potential advantages are not necessarily required of all embodiments. These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates a high-level block diagram of a conventional in-memory computing system;

FIG. 2 illustrates a matrix-vector multiply architecture using resistive memory (a key computational primitive), in accordance with an example embodiment;

FIG. 3 illustrates a conventional mapping between a matrix multiplication operation and a crossbar array;

FIG. 4A is a graph of raw conductances (in ADC units), in accordance with an example embodiment;

FIG. 4B illustrates three graphs for the mean, standard deviation and norm1 for 256 rows of an analog crossbar array, in accordance with an example embodiment;

FIG. 4C is a graph of standard deviation for rows of an example analog crossbar array, in accordance with an example embodiment;

FIG. 5A is a high-level block diagram of a conventional system for processing a kernel function;

FIG. 5B is a high-level block diagram of a first example system for processing a kernel function, in accordance with an example embodiment;

FIG. 6 is a workflow for implementing and processing a kernel function, in accordance with an example embodiment;

FIG. 7 is a workflow for implementing and processing a Gaussian kernel function, in accordance with an example embodiment;

FIG. 8 is a workflow for implementing and processing a Gaussian kernel function, in accordance with an example embodiment;

FIG. 9 is a workflow for an arc-cosine kernel given the analog crossbar configured with weights drawn from a Gaussian kernel function, in accordance with an example embodiment;

FIG. 10 is a workflow for correcting a row-wise standard deviation, in accordance with an example embodiment; and

FIG. 11 depicts a computing environment useful in connection with some aspects of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

### Introduction

The incorporation of kernel methods in machine learning has led to remarkable performance improvements in all areas of machine learning. Most kernels can be computed efficiently, but they often involve non-linearities that make the kernels difficult to split up. For example, the polynomial kernel k(x, y)=(x^{T}y+c)² is easy to compute but cannot be split up since it is non-linear.

Conventional approaches approximate kernels by randomly projecting the data into a different space and then performing a simple dot product in this space. The distribution from which the vectors of the projection are drawn is dictated by the type of kernel to be approximated. With such an approach, many computations can be split up and substantial performance gains can be attained. Conventional systems, however, perform all kernel operations using a digital processor. In contrast, in one or more exemplary embodiments, parts of the kernel algorithm are implemented using an analog processor. It is noted that an MVM operation has constant time complexity when an analog processor is used. As a result, the computation is much faster and more energy efficient using an analog processor for at least parts of the algorithm.

In one or more exemplary embodiments, kernels are approximated using in-memory computing, leading to computation speed up of many algorithms in machine learning and improvements in energy efficiency. For example, if one or more embodiments are applied to a well-known prior art neural network architecture with six self-attention layers and eight heads each, and dimension d=D=256, about 6 million operations per inference would be saved. This is achieved by sampling vectors from a kernel-specific distribution and programming the vectors into the crossbar array. (In one or more embodiments, the elements of the crossbar are programmed (configured) only once. Once they are programmed, the elements can be used to efficiently perform the MVM operations. This makes the programming cost negligible compared to the cost of constantly performing MVM operations in a digital processor. For example, in a typical low-power, always-on use-case, millions of MVM operations would be performed for one round of programming.) The kernel is then approximated by performing a matrix-vector multiplication operation using IMC and digital post-processing. In general, given a kernel function to be approximated, a probability distribution and scaling functions that are needed to approximate the kernel are inferred using well known techniques. A given number of vectors are then drawn from the specific distribution corresponding to the given kernel function and these vectors are programmed into a crossbar array comprising memristive devices.

In order to then approximate the kernel function evaluated on two vectors, the vectors are first projected into the new space using IMC and then scaling functions are applied in a digital post-processing unit. After the projection of the two vectors, the dot product is computed between the two projected vectors, which is then used as the approximated value of the kernel function.

One or more embodiments allow for multiple ways of programming the random vectors into the crossbar array:
1) if the kernel to be approximated is the Gaussian kernel, the probability distribution function is also Gaussian. This can be exploited since the devices of the crossbar array are also distributed according to a Gaussian when a single current pulse is applied to them; and
2) iterative programming can be used to program any vectors into the array up to a given precision. It is noted that, generally, matrices are programmed into the array, where the vector corresponds to a row or column of the array. In one or more embodiments, the rows or columns of that matrix must be corrected to have the correct standard deviation. If the formulation is x^{T}*M, then the standard deviation of the columns is corrected; if the formulation is M*x, then the standard deviation of the rows is corrected.

One or more embodiments also ensure that the standard deviations of the vectors are uniform by applying a digital correction of the standard deviation per vector. This can be achieved in two ways:
1) estimating, using read circuitry, the programmed conductances of the vectors and calculating the standard deviations using digital processing, and then using these values to correct for variations; and
2) assuming that the distribution is Gaussian, computing, using IMC, the vector-wise L1 norm of the weights using a single MVM, where the input vector is constant. A dot product of weights is performed, where the weights are all positive, with a vector of all ones, this results in the L1 norm of the vector. This identity is exploited to calculate the L1 norm of the vectors using an MVM operation. Since the rough L1 norm of a Gaussian vector with a fixed standard deviation can be calculated, and the measured L1 norm is available, the ratio between the two can be used in order to correct the vector-wise standard deviation.

### In-memory Computing

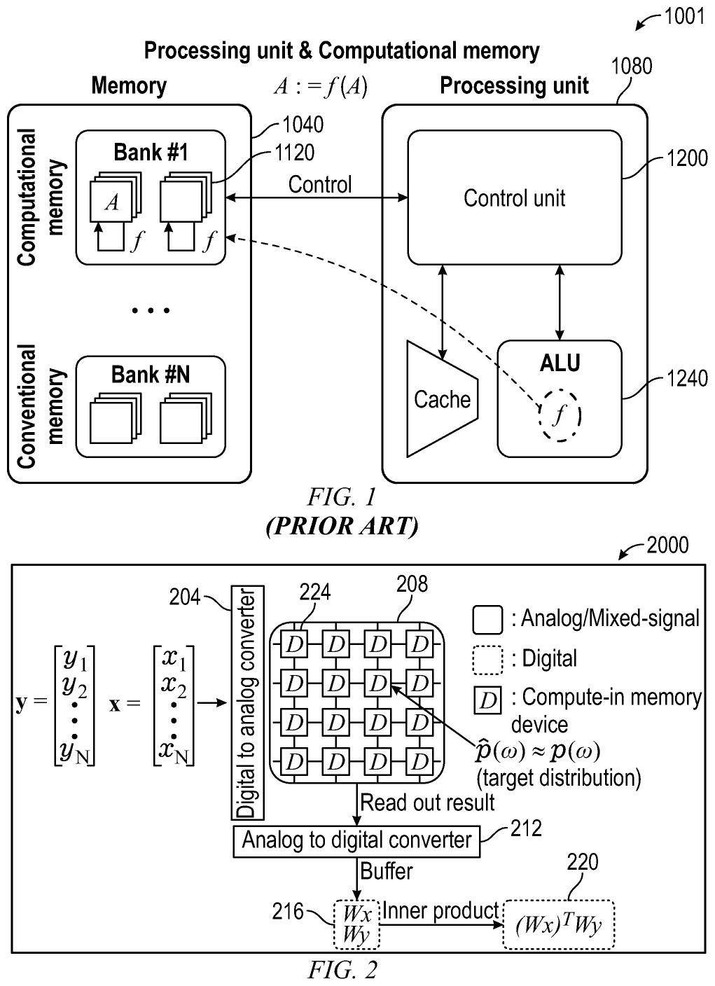

FIG. 1 illustrates a high-level block diagram of a conventional in-memory computing system 1001. Conventionally, “certain” computational tasks are performed in-place in memory. This is achieved by exploiting the physical attributes of the memory devices, their array level organization, the peripheral circuitry, the control logic, and the like. At no point during the computation is the memory contents read back and processed at the granularity of a single memory element. In the last few years, in-memory computing has found applications in a wide range of areas. These applications have varying degrees of computational complexity and requirements on data movement, both of which can be addressed by in-memory computing.

The application areas can be broadly classified in accordance with the computational precision that is required. Scientific computing, where very high precision is required, is at one end of the spectrum while stochastic computing that relies on imprecision is at the other end. Areas, such as signal processing (SP), machine learning (ML) and optimization, are in the middle. As illustrated in FIG. 1, a function ƒ(A) is performed in bank 1120 (computational memory) of a memory unit 1040. The results are then accessed by a processing unit 1080 (that includes a control unit 1200 and arithmetic logic unit (ALU) 1240).

### Matrix-Vector Multiply (MVM) Using Resistive Memory

FIG. 2 illustrates a matrix-vector multiply architecture 2000 using resistive memory (a key computational primitive), in accordance with an example embodiment. The in-place MVM operation is performed with [symbol] (1) time complexity and exploits analog storage capability and Kirchhoff s circuits laws. It is also possible to implement MVM with the matrix transpose. In one example embodiment, a digital-to-analog converter (DAC) 204 converts input vectors to analog form for input to a crossbar array 208 of compute-in-memory devices 224 that implements an analog MVM operation. The result of the MVM operation is then provided to a dot product unit 216 after conversion to digital form by analog-to-digital converter 212. The dot product unit 216 computes an inner product of the Wx and Wy outputs of the crossbar array 208 to generate output 220. The skilled artisan will be familiar with the design of crossbar arrays 208. The dot product unit 216 (and the units 520) may be implemented to perform dot products using a digital processing unit, a microprocessor, a field-programmable gate array, dedicated digital circuitry, and the like, as would be appreciated by the skilled artisan, given the teachings herein.

### Shift-Invariant Kernels

Shift-invariant kernel: A kernel function k is shift-invariant if k(x, y)=k(x−y). In other words, it does not matter what x, y are if the distance remains the same. (Note that shift-invariance does not imply symmetry. Example: k(x−y)=x−y, but most of the time, the kernel is symmetric, e.g., k(x−y)=(x−y)².)

Bochner's theorem: A continuous kernel k(x, y)=k(x−y) (i.e., also shift-invariant) on [symbol] is positive-definite if and only if k(x−y) is the Fourier transform of a non-negative measure.

Positive-definiteness of a function: A function k is positive-definite if the matrix A, given by A_{i,j}=k(xᵢ−xⱼ) for n inputs x₁, . . . , xₙ∈ [symbol] , is symmetric (if working in [symbol] ) and positive semi-definite, i.e., ∀x: x^{T}Ax≥0. (From that, it is taken that k must also be symmetric, i.e., k(x, y)=k(y, x).)

### Approximation of Shift-Invariant Kernels

From Bochner's theorem: For a symmetric, shift-invariant kernel k that is properly scaled, the Fourier transform is a proper probability distribution:

$$k ( x - y ) = \int p ( ω ) {e}^{j {ω}^{T} ( x - y )} d ω = {E}_{ω ∼ p} [ {{z}_{ω} ( x )}^{T} {z}_{ω} ( y ) ]$$

with z_{ω}(x)=\sqrt{2} cos(ω^{T}x+b) where the term z(x)_{ω}^{T}z_{ω}(y) is an unbiased estimate of k(x−y). The variance is too high, however, when only one value is considered. In one example embodiment, a draw from p(ω) is performed D times and a vector

$$z ( x ) = \frac{\sqrt{2}}{\sqrt{D}} cos ( [ {ω}_{1}^{T} x + {b}_{1} , … , {ω}_{D}^{T} x + {b}_{D} ] )$$

is calculated. The result is that z_{ω}(x)^{T}z_{ω}(y) is an unbiased, low-variance estimate of k(x−y), where k(x−y) is the Fourier transform of the non-negative measure p(ω) (which is used to sample ω). Most kernels used in practice can be approximated by z(x)^{T}z(y), where:

$$z ( x ) = \frac{h ( x )}{\sqrt{D}} ( {f}_{1} ( {ω}_{1}^{T} x ) , … , {f}_{1} ( {ω}_{m}^{T} x ) , … , {f}_{1} ( {ω}_{1}^{T} x ) , … , {f}_{1} ( {ω}_{m}^{T} x ) ) and$$

$$D = 1 \cdot m , ω ∼ p ( ω ) , h : {ℝ}^{d} \to ℝ and {f}_{i} : ℝ \to ℝ .$$

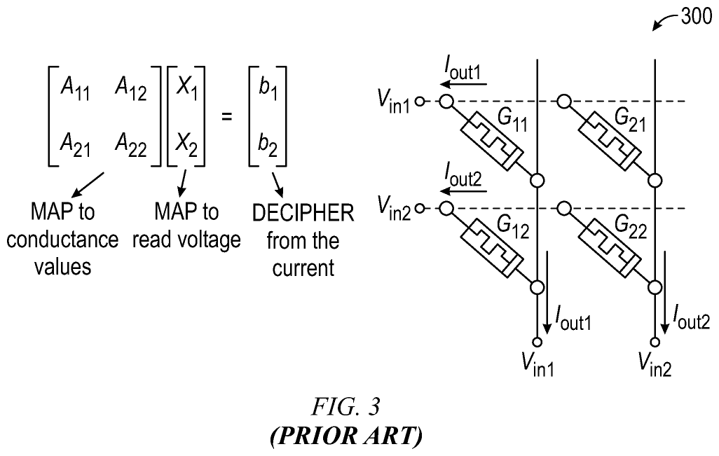

FIG. 3 illustrates a conventional mapping between a matrix multiplication operation and a crossbar array 300. The crossbar array 300 encodes the matrix elements to conductance values, where the rows of the matrix are drawn according to a kernel-specific distribution. By performing an MVM operation using the unit-cells of the crossbar array 300 and applying additional, kernel-specific scaling and transformations in a digital post-processing unit, the non-linear kernel functions are effectively approximated by a random projection.

### IMC-based Kernel Approximation

Given a kernel k(x, y), functions h: [symbol] → [symbol] , ƒ₁, . . . , ƒₗ: [symbol] → [symbol] and probability distribution p(ω), where these are chosen such that:

$$z ( x ) = \frac{h ( x )}{\sqrt{D}} ( {f}_{1} ( {ω}_{1}^{T} x ) , … , {f}_{1} ( {ω}_{m}^{T} x ) , … , {f}_{1} ( {ω}_{1}^{T} x ) , … , {f}_{1} ( {ω}_{m}^{T} x ) ) ,$$

where D=l·m, ω˜p(ω), and k(x, y)≈z(x)^{T}z(y), m weight vectors ωᵢ are drawn and programmed into a crossbar array comprising resistive memory devices 224. The transformation z: [symbol] → [symbol] is then done as follows:
1) compute the matrix-vector multiplication ωx using IMC;
2) perform element-wise transformations ƒ₁, . . . , ƒₗ using a look-up table; and
3) calculate the scalar

$$\frac{h ( x )}{\sqrt{D}}$$

via a look-up table or a digital processing unit, and multiply it with the output, thus approximating the kernel function k(x, y).

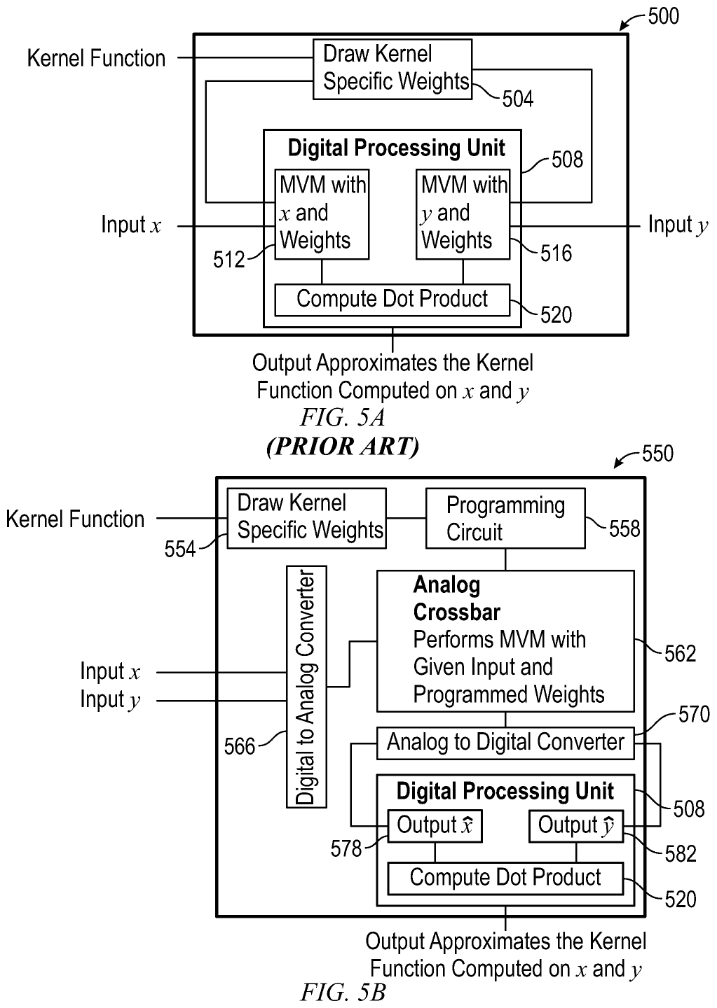

FIG. 5A is a high-level block diagram of a conventional system 500 for processing a kernel function. Kernel specific weights are drawn based on a specified kernel function by a kernel configuration unit 504. A digital processing unit 508 performs an MVM operation 512 on an input x and the kernel specific weights and performs an MVM operation 516 on an input y and the kernel specific weights. A dot product 520 is then computed on the results of the MVM operations 512, 516.

FIG. 5B is a high-level block diagram of a first example system 550 for processing a kernel function, in accordance with an example embodiment. Kernel specific weights 554 are drawn for a specified kernel function by, for example, a programming circuit 558. Inputs x and y are converted to analog by a digital-to-analog converter 566 and inputted to an analog crossbar 562 that has been configured by a programming circuit 558 based on the kernel specific weights; i.e., each element in the analog crossbar 562 is configured to represent a corresponding weight. The analog crossbar 562 performs MVM operations on the analog versions of inputs x and y, as described more fully below in conjunction with FIGS. 6-10. The analog-to-digital converter (ADC) 570 converts the analog output of the analog crossbar 562 into digital form. A digital processing unit 508 then performs a dot product 520 on the outputs 578, 582 of the MVM operations. The programming circuit 558 and the digital processing unit 508 may be implemented using a digital processing unit, a microprocessor, a field-programmable gate array, a hardware device, and the like. In one example embodiment, the programming circuit 558 and the digital processing unit 508 are implemented by the same device. The skilled artisan will have general familiarity with the use of digital circuits to control memories, processors, to program crossbar arrays, and the like, and given the teachings herein can implement, for example, a digital circuit to program the weights into the crossbar array. Throughout this disclosure, it should be noted that, generally, analog calculations can be performed in the crossbar array and digital processing can be used for control and the other depicted functionality.

FIG. 6 is a workflow 600 for implementing and processing a kernel function, in accordance with an example embodiment. Initially, a probability distribution is selected based on the given kernel function (operation 604). Weights from the selected probability distribution are sampled (operation 608). The devices 224 of the analog crossbar 562 are configured based on the sampled weights (operation 612) and the MVM operations are performed on the analog versions of the inputs x and y using the configured analog crossbar 562 (operation 616). The digital processing unit 508 then performs a dot product 520 on the outputs 578, 582 of the MVM operations (operation 620). The computed dot product will approximate the computation of the kernel function on the inputs x and y. Operations of the method 600 may be performed by the analog crossbar 562, the digital processing unit 508, and the programming circuit 558, under control of, for example, digital control circuitry in any one or more of 508 and 558, a separate digital control circuit, or the like.

### Example 1: Accelerated SVM Inference

The Gram matrix: consider the matrix G where G_{i,j} is given by any inner product <xᵢ,xⱼ> where xᵢ∈ [symbol] . Given N samples, this matrix has shape N×N and therefore scales quadratically in the training set size. The matrix is symmetric and positive semi-definite, meaning that G^{T}=G and ∀x,x^{T}Gx≥0.

SVM: The Support Vector Machine creates a linear decision boundary with a maximum margin to provide the most general classifier for a set of linearly separable points.

Kernel-SVM: The kernelized SVM is used for classifying data that is not linearly separable with the help of kernels. For training, it uses the Gram matrix K, where K_{i,j}=k(xᵢ, xⱼ) with a kernel function k.

The well-known Kernel “trick” is a widely used technique in machine learning. This “trick” recognizes that every kernel can be expressed as a dot product in a (potentially) very high dimensional space: k(x, y)=<z(x), z(y)>. One goal is to work in that space without explicitly calculating z(x). The idea is to make sure that z(x) only appears in the form of a dot product. If that is the case, k(x, y) can always be used and z(x) does not need to be explicitly calculated.

Kernel-SVMs implicitly allow the calculation in a high-dimensional space.

Inference in Kernel-SVMs: As will be appreciated by the skilled artisan, given a new point y that needs to be predicted, the prediction can be computed as ƒ(y)=Σᵢ₌₁^{N}cᵢk(xᵢ, y) which has time complexity [symbol] (Nd) where N are the number of training samples and d is the dimension of the data. This is particularly disadvantageous if many of the values cᵢ are non-zero.

Inference in Approximated-Kernel-SVMs: As will be appreciated by the skilled artisan, here, the prediction can be computed as follows: ƒ(y)=Σᵢ₌₁^{N}cᵢk(x_{I}, y)≈Σᵢ₋₁^{N}cᵢz(xᵢ)^{T}z(y)=(Σᵢ₌₁^{N}cᵢz(xᵢ)^{T}z(y)=w^{T}z(y). Assuming that the complexity for calculating z(y) is in [symbol] (Dd), the final complexity is [symbol] (d+Dd). It should be noted that, generally, D<<N.

It is noted that the transformation z(y) is, according to the above, a matrix-vector multiplication followed by scaling and multiplying with h(z). The matrix at hand is ω where each row ωᵢ was drawn from a kernel-specific distribution p(ω) and the input vector is y. By performing this operation using IMC, the complexity is reduced to [symbol] (d) because the MVM operation using IMC has complexity [symbol] (1).

### Example 2: Accelerated Transformer Inference on Long Input Sequences—Transformer

Consider a network architecture for various tasks, e.g., seq2seq translation, with a sequence of N (referred to as the sequence length) tokens of dimension d. The transformer operates on the sequence at once, i.e., there is no sequential processing. The main pillar of the transformer is the attention layer: given input X∈ [symbol] the input is transformed into Q, K, V using linear transformations W_{Q}, W_{K}, W_{V}, respectively. These transformations can be performed using IMC, as the matrices are static. The input is then pushed through the attention mechanism:

$$Attention ( Q , K , V ) = softmax ( \frac{{QK}^{T}}{\sqrt{d}} ) V where$$

$$softmax {( x )}_{i} = \frac{{e}^{{x}_{i}}}{{\sum }_{j = 1}^{d} {e}^{{x}_{j}}} .$$

The matrices Q, K, V are all dynamic and therefore, none of the matrix-matrix multiplications can be performed using IMC. The skilled artisan will be generally familiar with such transformations, and, given the teachings herein, can adapt appropriate known techniques to implement one or more embodiments.

Problem with the Transformer: The computation

$$softmax ( \frac{{QK}^{T}}{\sqrt{d}} ) V$$

is in [symbol] (N²d) because the attention matrix A=exp(QK^{T})∈ [symbol] needs to be calculated explicitly. The problem is that the computational complexity scales quadratically with the sequence length and, therefore, many applications requiring long input sequences are not possible.

Conventional techniques solve this problem by approximating the exponential in the softmax using random features (i.e., projecting them onto another space and then doing the dot product later; see also description above). Precisely, A=exp(QK^{T}) where A_{i,j}=exp(qᵢ^{T}kᵢ) and where qᵢ denotes the i-th row vector of Q. The identity

$$exp ( {x}^{T} y ) = exp ( \frac{{x}^{T} x}{2} - \frac{- {‖ x - y ‖}^{2}}{2} + \frac{{y}^{T} y}{2} )$$

and that the term

$$exp ( - \frac{- {‖ x - y ‖}^{2}}{2} )$$

is a shift-invariant kernel (Gaussian kernel) that can be approximated are noted. The function exp (x^{T}y) is therefore approximated using

$${f}_{1} = sin , {f}_{2} = cos , h ( x ) = exp ( \frac{{‖ x ‖}^{2}}{2} ) , p ( ω ) = 𝒩 ( 0 , {I}_{d} ) .$$

This transformation is denoted with z(x).

Using the transformation z(x), the Attention layer can be rewritten to z(Q)z(K)^{T}V and it is noted that the softmax disappeared. The order of computation is now free to be selected and the N² attention matrix does not have to be explicitly computed anymore. The new computation is z(Q)(z(K)^{T}V) where the brackets indicate the order. Note that z(Q)∈ [symbol] , z(K)∈ [symbol] , V∈ [symbol] .

The space and time complexity of the Transformer is [symbol] (N²d), [symbol] (N²+Nd). The space and time complexity of a typical conventional neural network architecture is [symbol] (NDd), [symbol] (ND+Nd+Dd). The transformations z(Q/K) require 2×NDd extra computations. Using IMC, each individual transformation of a vector q/kᵢ is in [symbol] (1) and the number of required operations reduces to 2×N. 2×Dd many operations per attention head are therefore saved. With, for example, six self-attention layers and eight heads each, and dimension d=D=256 , approximately 6 million operations per inference would be saved.

### Embodiment 2: Controlling the row-Wise Standard Deviation for Approximating the Gaussian Kernel

In the following, assume the MVM is W*x; columns are referred to if the MVM is carried out as such: xT*W. If the kernel to be approximated is the Gaussian kernel, the distribution from which the weights are drawn is a simple Gaussian, i.e., the rows ω are drawn according to ω˜ [symbol] (0, I_{d}). Each row of the matrix ω should have the same standard deviation (std). This embodiment illustrates options to achieve this.

### Algorithm

Program device conductances in the analog crossbar 562.

### Preliminaries

Each device 224 in the analog crossbar 562 is organized in a differential manner. This means that every weight g is represented by a differential pair (g₊, g₋) so that g=g₊−g₋. The conductance value of these devices 224 can be changed by applying specific current pulses with varying length and amplitude. For example, applying single pulses with high amplitude will set the device 224 into a low conductance state.

In one example embodiment, iterative programming is used for setting individual devices 224 to target conductances. This method works by iteratively reading the conductance of a device 224 and applying a current pulse to the device 224, until the read conductance is matches the target conductance (optionally, within some range, which can be determined heuristically as known by the skilled artisan).

### Programming Device Conductances

### Embodiment 1

### Solution 1

In one example embodiment, using a standard personal computer (PC), a matrix is generated where the elements are drawn from a Gaussian distribution. The rows in this matrix can be orthogonalized by, for example, the Gram-Schmidt algorithm. Iterative programming is then used to program the weights into the crossbar array 562. Since iterative programming also introduces imprecisions, standard deviation (std) correction of the programmed row-wise weights may still need to be performed (in one or more embodiments, the Gaussian weights that were drawn in floating point on a PC are programmed into the crossbar array 562; however, the standard deviation of the programmed row-wise weights might still need correction).

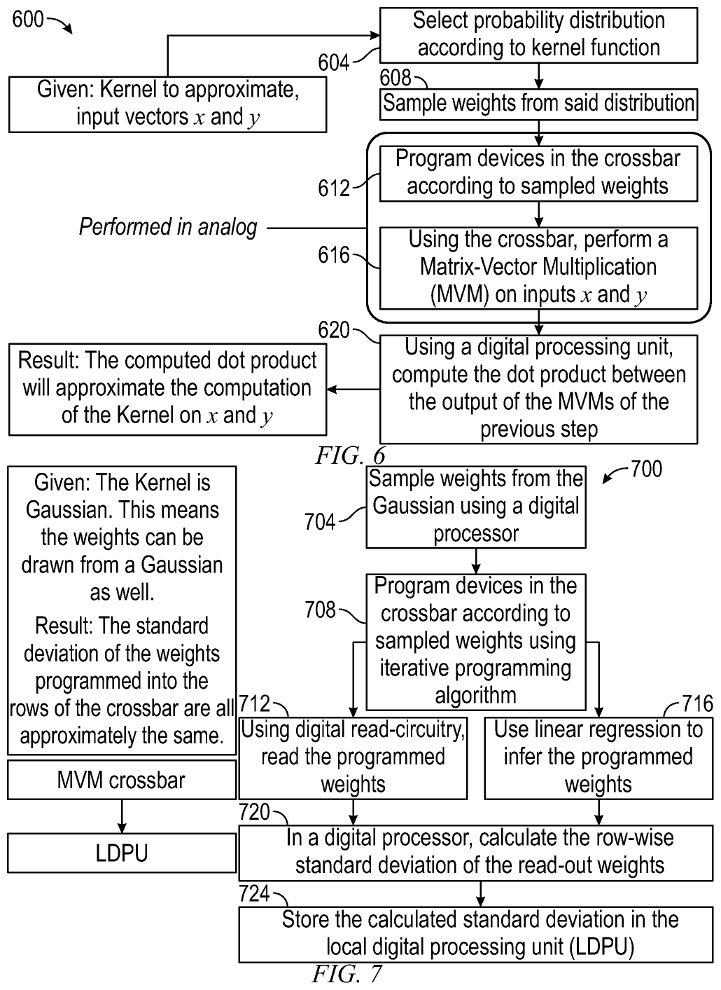

FIG. 7 is an exemplary workflow 700 for implementing and processing a Gaussian kernel function, in accordance with an example embodiment. Initially, weights from the selected Gaussian probability distribution are sampled (operation 704). The devices of the analog crossbar 562 are configured based on the sampled weights using an iterative programming algorithm (operation 708). Depending on the implementation, either the programmed weights are read using digital read-circuitry (operation 712) or the programmed weights are inferred using linear regression (operation 716). The determination of the weights enables the checking of the standard deviation to ensure that it is constant for each row. The column-wise standard deviation of the read-out weights or inferred weights is calculated using the digital processing unit 508 (operation 720) and the calculated standard deviation is stored in the local digital processing unit 508 (operation 724). Note that according to the crossbar diagram in FIG. 2, it is column-wise standard deviation. Rows of the sampled weight matrix are programmed on the crossbar columns and vice versa. So, it is row-wise with respect to the weight matrix, and column-wise with respect to the crossbar matrix. The inverse of the standard deviation is stored and then multiplied by the output of the MVM at the specific row. This basically leads to unit standard deviation. It is noted that the standard deviation of the weights programmed into the rows of the analog crossbar 562 are all approximately the same. Moreover, inside the digital processing unit 508, each element of the MVM output is multiplied by a value and added to another value. The standard deviation of the rows of the MVM analog crossbar 562 can then be corrected. (In one example embodiment, the digital read-circuitry activates a row of devices in the analog crossbar 562 and reads the corresponding weights in parallel. The weights may also be read one device 224 at a time. It is noted that such digital read-circuitry is, in and of itself, well known in the art. Reading out single devices, in serial or in parallel, is known to the skilled artisan. Operations of the method 700 may be performed by the analog crossbar 562, the digital processing unit 508, and the programming circuit 558, under control of, for example, digital control circuitry in any one or more of 508 and 558, a separate digital control circuit, or the like.

Advantages of the above technique include that other matrices, such as orthonormal ones, may be used since the weights can be sampled on a digital processing unit 508 and that the matrices are guaranteed to follow a true Gaussian since they are generated in a digital processing unit 508. Costs include that high-resolution ADCs are required for reading the programmed conductances (unless linear regression is used for determining the weights) and that the programming of the analog crossbar 562 can be time consuming. In one or more embodiments, read circuitry includes, essentially, the ADC with included circuits that generate the input read voltages.

### Solution 2:

When devices 224 are set to high conductance values, they naturally follow a Gaussian distribution. In one example embodiment, for every differential pair, one device 224 that will be programmed (i.e., either the device 224 corresponding to a negative weight or the device 224 corresponding to a positive weight) is chosen. For these devices 224, many low-amplitude pulses are applied to set them to high conductance (called a SET operation) to ensure uniformity of the devices 224. For these devices 224, a smaller number of pulses (such as one) that decreases the conductance are applied in a uniform manner.

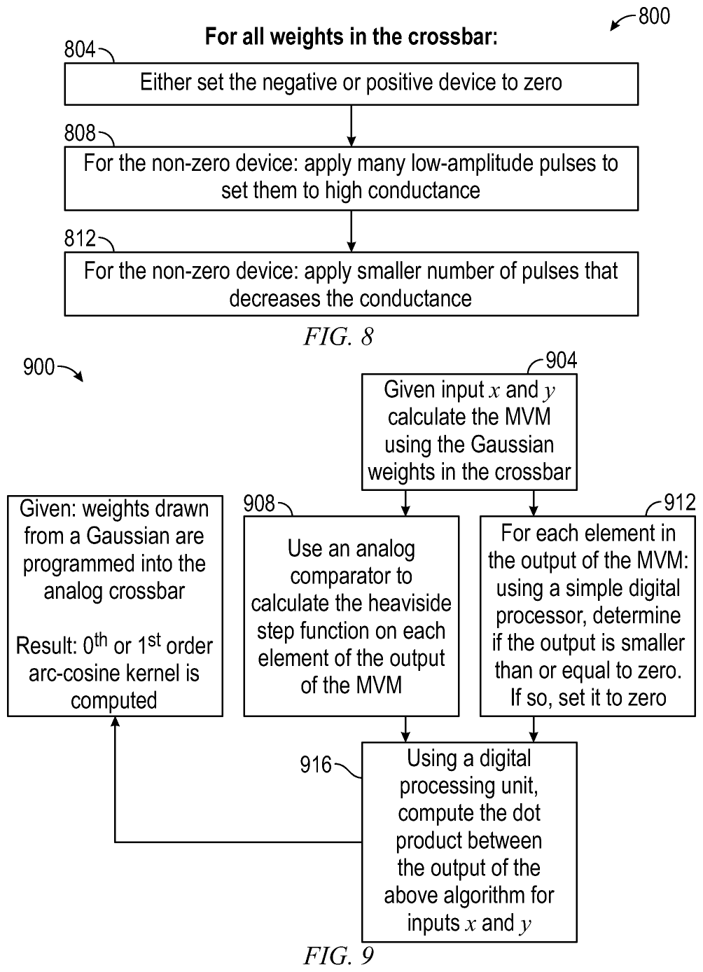

FIG. 8 is a workflow 800 for implementing and processing a Gaussian kernel function, in accordance with an example embodiment. In one example embodiment, for all weights in the analog crossbar 562, set either the device 224 corresponding to a negative weight or the device corresponding to a positive weight to zero (operation 804). For the device 224 not set to zero, many low-amplitude pulses are applied to set the device to high conductance, where the high conductance is relatively similar across all devices 224 in the analog crossbar 562 (operation 808).

For the device 224 not set to zero, a smaller number (such as one) of pulses with high amplitude are applied to decrease the conductance (operation 812). In one example embodiment, the pulse is applied in parallel to all devices 224 of the analog crossbar 562. As noted below, the variations in the inherent characteristics of the devices 224 of the analog crossbar 562 result in a Gaussian distribution of the conductance values resulting from operation 812. The determination of the number of pulses and the amplitude of the pulses to attain specified conductances is, in and of itself, well known in the art. It is noted that in one or more embodiments, the analog crossbar 562 is not programmed with specific values for the weights; rather, the variations in the inherent characteristics of the devices 224 are relied upon to provide the Gaussian distribution. Operations of the method 800 may be performed by the analog crossbar 562, the digital processing unit 508, and the programming circuit 558, under control of, for example, digital control circuitry in any one or more of 508 and 558, a separate digital control circuit, or the like.

Advantages of the above technique include that only one iteration of programming of the analog crossbar 562 is required (excluding the initial SET operation) and no read circuitry is required. Costs include that weight distribution may not be exactly Gaussian (due to the variations in the inherent characteristics of the devices 224) and a limitation resulting from the distribution and magnitude that is generated by applying one pulse. The latter is ultimately a result of the characteristics of the devices. If too many pulses are applied and the conductance decreases too much, the distribution is no longer Gaussian. When it is Gaussian, then sometimes the high conductances lead to high currents which leads to non-linearities in the ADC.

### Correction of Row-Wise Standard Deviations

### Solution 1:

In one example embodiment, the approximation of the conductances is read using read-circuitry and the row-wise standard deviation \hat{σ}ᵢ is computed. Since an MVM operation is a linear operation, the output (ωx)ᵢ can be divided by \hat{σ}ᵢ to obtain the unit standard deviation. Advantages include the precise computation of the standard deviation. Costs include an imprecise approximation of true conductances, and the technique requires periphery for reading the approximate conductances.

### Solution 2:

In one example embodiment, linear regression on the MVM output results is used to infer the programmed conductances with high precision. As in option 1, the standard deviation is computed, and the output is scaled. Advantages include a more precise estimate of the programmed conductances. Costs include the relatively expensive linear regression that needs to be performed in an external computer.

### Solution 3:

In one example embodiment, for the devices 224 in the crossbar array 562 corresponding to positive weights, a constant voltage is applied across all rows and read values of the ADCs 570. This is equivalent to doing an MVM operation with an input vector of all ones: y₊=G₊1. The i-th entry in y₊ now holds the sum of the devices 224 in the crossbar array 562 corresponding to positive weights of the i-th row in G₊. The same is done for G₋.

The sum y₊+y₋ now is the vector that holds the row-wise L1-Norm of the G matrix. Note that this is only the case when, for all differential pairs, there is always one device 224 that is programmed to 0; otherwise, the calculation would use |g₊|+|g₋| rather than |g|.

For a Gaussian vector with fixed size, zero mean, and standard deviation=d, the L1-Norm is approximately always the same. Denote this by η and, given the calculated L1-Norm of the i-th row of G, denoted by ζ, the output (Gx)ᵢ can be scaled by

$$\frac{η}{ζ}$$

to approximately achieve the target standard deviation d. Advantages of the above technique include that no read circuitry is required since the calibration relies only on performing an MVM operation, and the technique is fast and efficient. Costs include imprecision from the MVM operation, such as imprecision introduced from using the L1-Norm to correct for the standard deviation. This assumes that the devices 224 follow a true Gaussian distribution with uniform initial standard deviation across the row.

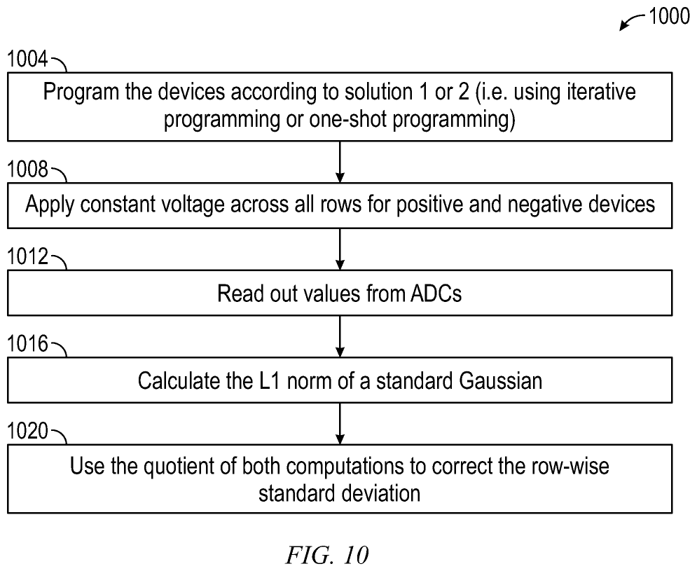

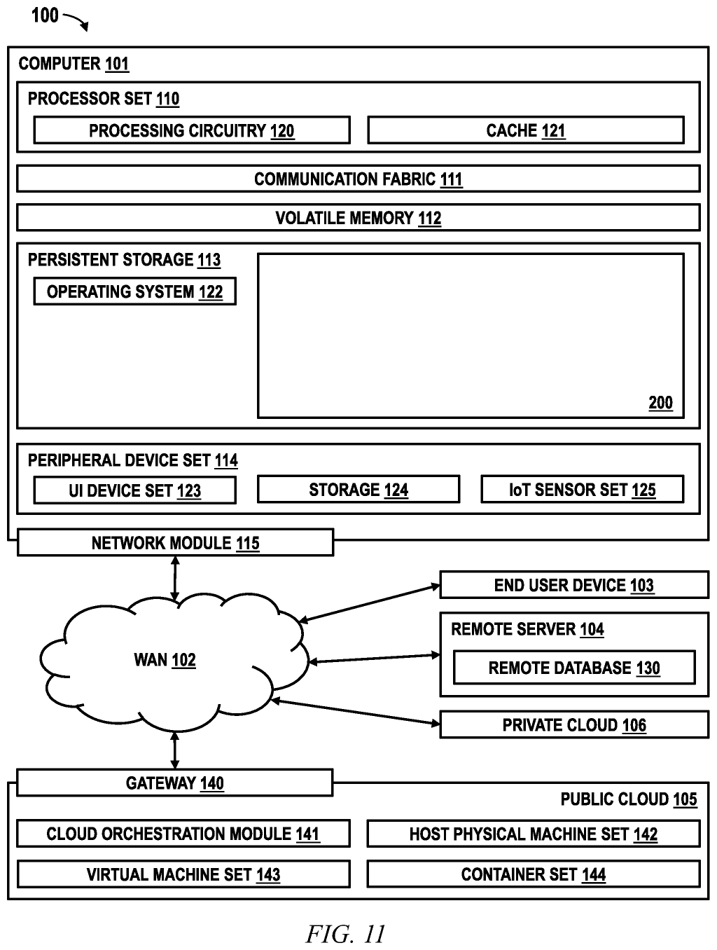

FIG. 10 is a workflow 1000 for correcting a row-wise standard deviation, in accordance with an example embodiment. In one example embodiment, the devices 224 in the analog crossbar 562 are programmed according to solution 1 or 2 above, using iterative programming or one-shot programming (operation 1004). A constant voltage is applied across all rows of devices 224 in the analog crossbar 562, for both the devices 224 corresponding to a negative weight and the devices 224 corresponding to a positive weight (operation 1008). Values are read from the ADCs 570 (indicative of performing MVM operations at a constant voltage) (operation 1012) and the L1 norm of a standard Gaussian is calculated (operation 1016). The row-wise standard deviation is corrected by dividing the result of operation 1016 (the numerator) by the result of the operation 1012 (the denominator) (operation 1020). For the avoidance of doubt, the numerator should be the L1 norm of the Gaussian (not the inferred L1 norm of the crossbar). Operations of the method 1000 may be performed by the analog crossbar 562, the digital processing unit 508, and the programming circuit 558, under control of, for example, digital control circuitry in any one or more of 508 and 558, a separate digital control circuit, or the like.

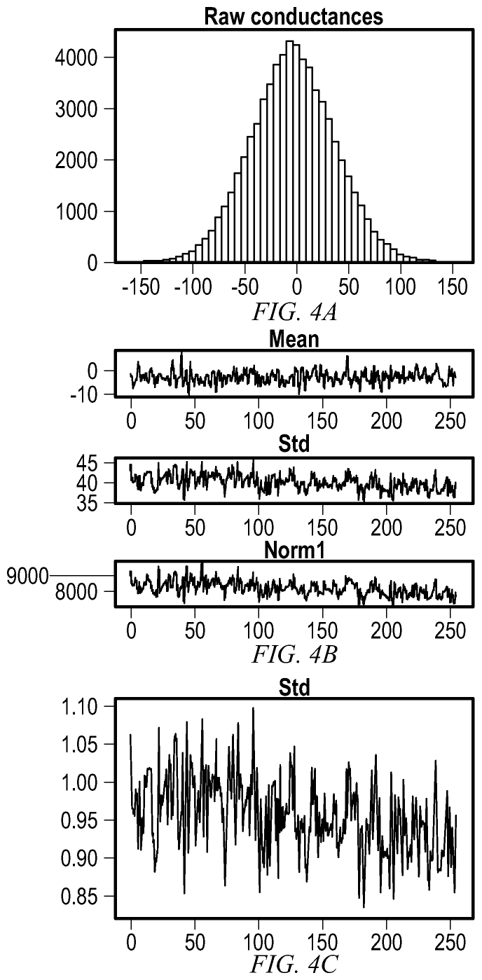

FIG. 4A is a graph of raw conductances (in ADC units) , in accordance with an example embodiment. The graph was generated by reading device weights (ADC values) after applying two low-amplitude pulses to a high-conductance-state analog crossbar 562. The range is dependent on the hardware used, the ADC implementation, and other factors. What is depicted in FIG. 4A is, basically, the conductance of single devices in ADC units, which varies in FIG. 4A from +/−130 to 150.

FIG. 4B illustrates three graphs for the mean, standard deviation and norm1 for 256 rows of an analog crossbar array 562 that was programmed using solution 2 from step 1 of the algorithm (single shot), in accordance with an example embodiment.

FIG. 4C is a graph of standard deviation for rows of an example analog crossbar array 562, in accordance with an example embodiment. Using the L1-Norm, the standard deviation can be corrected to approximately yield the target standard deviation (in this case, 1.0).

### Embodiment 3: IMC-based Kernel Approximation with Near-Memory Activation

In addition to Gaussian kernels, arc-cosine kernels can be closely connected to neural networks, which include feature spaces that mimic the sparse, non-negative, distributed representations of single-layer threshold networks. For arc-cosine kernels, the probability distribution p(ω) is the Gaussian distribution, but the element-wise activation transformations ƒ₁, . . . ƒₗ are different. This powerful class of kernels enables the effective implementation of their simple activation functions near-crossbar array without digital processing: when using zeroth-order arc-cosine kernel, the only activation function is the Heaviside step function, i.e., ƒ₁(ωᵢ^{T}x)=0.5(1+sign(ωᵢ^{T}x)). In one example embodiment, it is implemented directly with an analog comparator that eliminates the need for an ADC and digital processing.

When using a first-order arc-cosine kernel, the only activation function is ReLU, i.e., ƒ₁(ωᵢ^{T}x)=max{0, ωᵢ^{T}x} which is simpler to compute than the sine and cosine activations used in Gaussian kernels. Advantages of the above technique include no need for a digital post-processing unit (LDPU) when using an analog comparator; and simple digital hardware when the zero-check is performed. Costs include that only arc-cosine kernels can be approximated.

FIG. 9 is a workflow 900 for an arc-cosine kernel given the analog crossbar 562 configured with weights drawn from a Gaussian kernel function, in accordance with an example embodiment. In one example embodiment, the MVM operations are performed on the analog versions of inputs x and y using the configured analog crossbar 562 (operation 904). Depending on the implementation, either an analog comparator is used to calculate the Heaviside step function on each element of the output of the MVM operation (operation 908) or, for each element in the output of the MVM operation, a determination is made of whether the output is smaller than or equal to zero and, if the output is smaller than or equal to zero, the output is set to zero (for each element in the output) (operation 912). The dot product is computed between the outputs of operation 908, 912 for inputs x and y (operation 916). The result is the 0^{th} or 1^{st} order arc-cosine kernel. In one example embodiment, operations 908, 912, and 916 are performed using a digital processing unit. In one example embodiment, the ADC 212 is modified to include circuitry that performs the analog comparison of operation 908. Indeed, the analog comparator circuitry that can be used to produce a binary MVM output can replace the ADCs, or potentially be added to the ADC 212 with a switch that selects between the ADC and the comparator functions. The analog comparator circuitry can be a much smaller, faster, and more power efficient circuit than an ADC which does multi-bit digitization of the MVM output. Operations of the method 900 may be performed by the analog crossbar 562, the digital processing unit 508, and the programming circuit 558, under control of, for example, digital control circuitry in any one or more of 508 and 558, a separate digital control circuit, or the like.

Given the discussion thus far, it will be appreciated that, in general terms, an exemplary method include operations of determining, using a digital processing unit 558, a probability distribution corresponding to the kernel function; sampling, using the digital processing unit 558, weights from the determined probability distribution corresponding to the given kernel function; programming, using a digital processing unit 558, memristive devices 224 of an analog crossbar 562 based on the sampled weights, where each memristive device 224 of the analog crossbar 562 is configured to represent a corresponding weight; performing two matrix-vector multiplication operations on a first analog input and a second analog input using the programmed crossbar 562; and computing, using the digital processing unit 558, a dot product on results of the matrix-vector multiplication operations.

In one example embodiment, the first analog input is designated as x and the second analog input is designated as y, the method further comprising converting an input vector x to the analog input x and converting an input vector y to the analog input y by a digital-to-analog converter 566, and inputting the analog input x and the analog input y to the analog crossbar 562.

In one example embodiment, using read circuitry, programmed conductances of the analog crossbar 562 corresponding to each vector of weights are estimated; standard deviations are calculated using digital processing; and the standard deviations values are used to correct for variations.

In one example embodiment, using in-memory computing, a vector-wise L1 norm of the weights is computed using a single matrix-vector multiplication operation, where an input vector of the analog crossbar 562 is constant, by performing a dot product of weights with a vector of all ones, where the weights are all positive; a ratio between the computed vector-wise L1 norm of the weights and a measured L1 norm is computed; and the vector-wise standard deviation is corrected using the ratio.

In one example, a method 700 for approximating a kernel function comprises determining, using a digital processing unit 558, a probability distribution corresponding to the kernel function; sampling, using the digital processing unit 558, weights from the determined probability distribution corresponding to the given kernel function (operation 704); programming, using the digital processing unit 558, memristive devices 224 of an analog crossbar 562 based on the sampled weights, where each memristive device 224 in the analog crossbar 562 is configured to represent a corresponding weight (operation 708); determining, using the digital processing unit 558, the programmed weights of the analog crossbar 562 (operation 712, 716); calculating, using the digital processing unit 558, a column-wise standard deviation of the determined programmed weights using digital processing (operation 720); storing the calculated row-wise standard deviation in a digital processing unit 508 (operation 724); and correcting, using the digital processing unit 558, the standard deviation of rows of the analog crossbar 562 using the calculated row-wise standard deviation.

In one example embodiment, the programmed weights are determined by reading the programmed weights using read-circuitry (operation 712).

In one example embodiment, the programmed weights are determined by performing linear regression on output results of a corresponding matrix-vector multiplication operation (operation 716).

In one aspect, a method for approximating a kernel function comprises, for all weights programmed in an analog crossbar 562, selecting a device 224 corresponding to one of a negative weight and a positive weight and setting the selected device 224 to zero (operation 804); for each device 224 not set to zero, applying a plurality of low-amplitude pulses to set a conductance of the corresponding device 224 to a high conductance (operation 808); and, for each device 224 not set to zero, applying one or more pulses with high-amplitude to decrease the conductance of the corresponding device 224 (operation 812).

In one example embodiment, using read-circuitry, approximations of the conductances are read; a row-wise standard deviation \hat{σ}ᵢ is computed; and an output (ωx)ᵢ is divided by the row-wise standard deviation \hat{σ}ᵢ to derive a unit standard deviation.

In one example embodiment, programmed conductances of the analog crossbar 562 are inferred by performing linear regression on outputs of a corresponding matrix-vector multiplication operation; a row-wise standard deviation \hat{σ}ᵢ is computed; and an output (ωx)ᵢ is divided by the row-wise standard deviation \hat{σ}ᵢ to derive a unit standard deviation.

In one aspect, a method 1000 for correcting row-wise standard deviation comprises programming, using a digital processing unit 558, a plurality of devices 224 in an analog crossbar 562 (operation 1004); applying a constant voltage across all rows in the analog crossbar 562, where each row comprises a device 224 corresponding to a negative weight or a device 224 corresponding to a positive weight (operation 1008); reading, using the digital processing unit 558, a value via a plurality of analog-to-digital converters 570 (operation 1012); calculating, using the digital processing unit 558, an L1 norm of a standard Gaussian (operation 1016); and correcting, using the digital processing unit 558, the row-wise standard deviation by dividing the L1 norm of the standard Gaussian by the read value (operation 1020).

In one aspect, a method 900 for processing an arc-cosine kernel comprises determining, using a digital processing unit 558, a probability distribution corresponding to an arc-cosine kernel function; sampling, using the digital processing unit 558, weights from the determined probability distribution corresponding to the arc-cosine kernel function; programming, using the digital processing unit 558, a plurality of devices 224 of an analog crossbar 562 based on the sampled weights, where each device 224 in the analog crossbar 562 is configured to represent a corresponding weight; performing a matrix-vector multiplication operation using the programmed crossbar array 562 (operation 904); pre-processing elements of outputs of the matrix-vector multiplication operation (operation 908, 912); and computing, using the digital processing unit 558, a dot product on the pre-processed elements of the outputs of the matrix-vector multiplication operation (operation 916).

In one example embodiment, the pre-processing comprises calculating a Heaviside step function on each element of the output of the matrix-vector multiplication operation using an analog comparator (operation 908).

In one example embodiment, the pre-processing further comprises determining, using the digital processing unit 558, for each element in the output of the matrix-vector multiplication operation, whether the output is smaller than or equal to zero; and setting, using the digital processing unit 558, in response to the output being smaller than or equal to zero, the output to zero (operation 912).

In another aspect, referring to FIG. 5B, an exemplary apparatus includes a programming circuit 558; an analog crossbar array 562, coupled to the programming circuit, and having an input and an output; a digital to analog converter 566 coupled to the input of the analog crossbar array; an analog to digital converter 570 coupled to the output of the analog crossbar array; and a digital processing unit 508 coupled to the analog to digital converter. The programming circuit is configured to program weights into the analog crossbar array. The analog crossbar array is configured to perform matrix vector multiplication with first and second inputs x, y obtained from the digital to analog converter based on the programmed weights. The digital processing unit is configured to computer a dot product of the outputs \hat{x}, ŷ) of the matrix vector multiplication corresponding to the first and second inputs, obtained from the analog to digital converter. The apparatus can carry out any of the methods described herein, as desired.

One or more embodiments can be used for a variety of practical applications; for example, once the weights are set, inferencing can be carried out using the kernel approximations. The inference could be, for example, any machine learning application such as recognizing one or more objects, controlling an industrial robot or steering an autonomous vehicle based on the recognition.

As noted above, in one example embodiment, using a standard personal computer (PC), a matrix is generated where the elements are drawn from a Gaussian distribution. Discussion of FIG. 11 follows. This computer can carry out conventional, Von Neumann type computations for a variety of pertinent applications. In another aspect, a module could be added to FIG. 11 with in-memory computation, as described herein, to implement improved neural networks. Furthermore, to implement any of the digital circuitry described herein, computer-aided semiconductor integrated circuit (IC) logic design, simulation, test, layout, and/or manufacture can be employed. The computerized design process can represent functional and/or structural design features in a design structure generated using electronic computer-aided design (ECAD). A suitable hardware-description language (HDL) can be employed. The skilled artisan can synthesize digital logic circuits to carry out desired control and other functionality, using known computer-aided design techniques implemented on a machine such as depicted in FIG. 11.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Refer now to FIG. 11.

Computing environment 100 contains an example of an environment for the execution of at least some of the computer code involved in performing appropriate methods, as seen at 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 11. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments of the invention, or elements thereof, can thus be implemented in the form of an apparatus including a memory and at least one processor that is coupled to the memory and operative to perform exemplary method steps. FIG. 11 depicts a computer system that may be useful in implementing one or more aspects and/or elements of the invention. See discussions above, noting that analog processing is carried out in the analog crossbar array, for example.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is

1. A method for approximating a kernel function, the method comprising:
determining, using a digital processing unit, a probability distribution corresponding to the kernel function;
sampling, using the digital processing unit, weights from the determined probability distribution corresponding to the given kernel function;
programming, using a digital processing unit, memristive devices of an analog crossbar based on the sampled weights, where each memristive device of the analog crossbar is configured to represent a corresponding weight;
performing two matrix-vector multiplication operations on a first analog input and a second analog input using the programmed crossbar; and
computing, using the digital processing unit, a dot product on results of the matrix-vector multiplication operations.

2. The method of claim 1, wherein the first analog input is designated as x and the second analog input is designated as y, further comprising:
converting an input vector x to the analog input x and converting an input vector y to the analog input y by a digital-to-analog converter; and
inputting the analog input x and the analog input y to the analog crossbar.

3. The method of claim 1, further comprising:
estimating, using read circuitry, programmed conductances of the analog crossbar corresponding to each vector of weights;
calculating standard deviations using digital processing; and
using the standard deviations values to correct for variations.

4. The method of claim 1, further comprising: computing, using in-memory computing, a vector-wise L1 norm of the weights using a single matrix-vector multiplication operation, where an input vector of the analog crossbar 562 is constant, by performing a dot product of weights with a vector of all ones, where the weights are all positive;
computing a ratio between the computed vector-wise L1 norm of the weights and a measured L1 norm; and
using the ratio to correct the vector-wise standard deviation.

5. The method of claim 1, further comprising:
programming, using the digital processing unit, at least one of the memristive devices of the analog crossbar;
applying a constant voltage across all rows in the analog crossbar, where each row comprises at least one of the memristive devices corresponding to a negative weight or at least one of the memristive devices corresponding to a positive weight;
reading, using the digital processing unit, a value via a plurality of analog-to-digital converters;
calculating, using the digital processing unit, an L1 norm of a standard Gaussian; and
correcting, using the digital processing unit, the row-wise standard deviation by dividing the L1 norm of the standard Gaussian by the read value.

6. The method of claim 5, further comprising pre-processing elements of outputs of the matrix-vector multiplication operation.

7. The method of claim 6, wherein the pre-processing comprises calculating a Heaviside step function on each element of the output of the matrix-vector multiplication operation using an analog comparator.

8. The method of claim 6, wherein the pre-processing further comprises:
determining, using the digital processing unit, for each element in the output of the matrix-vector multiplication operation, whether the output is smaller than or equal to zero; and
setting, using the digital processing unit, in response to the output being smaller than or equal to zero, the output to zero.

9. A method for approximating a kernel function, the method comprising:
determining, using a digital processing unit, a probability distribution corresponding to the kernel function;
sampling, using the digital processing unit, weights from the determined probability distribution corresponding to the given kernel function;
programming, using the digital processing unit, memristive devices of an analog crossbar based on the sampled weights, where each memristive device in the analog crossbar is configured to represent a corresponding weight;
determining, using the digital processing unit, the programmed weights of the analog crossbar;
calculating, using the digital processing unit, a column-wise standard deviation of the determined programmed weights using digital processing;
storing the calculated standard deviation in a digital processing unit; and
correcting, using the digital processing unit, the standard deviation of rows of the analog crossbar using the calculated row-wise standard deviation.

10. The method of 9, wherein the programmed weights are determined by reading the programmed weights using read-circuitry.

11. The method of 9, wherein the programmed weights are determined by performing linear regression on output results of a corresponding matrix-vector multiplication operation.

12. A method for approximating a kernel function, the method comprising:
for all weights programmed in an analog crossbar, selecting a device corresponding to one of a negative weight and a positive weight and setting the selected device to zero;
for each device not set to zero, applying a plurality of low-amplitude pulses to set a conductance of the corresponding device to a high conductance; and
for each device not set to zero, applying one or more pulses with high-amplitude to decrease the conductance of the corresponding device.

13. The method of 12, further comprising:
reading, using read-circuitry, approximations of the conductances;
computing a row-wise standard deviation \hat{σ}ᵢ; and
dividing an output (ωx)ᵢ by the row-wise standard deviation \hat{σ}ᵢ to derive a unit standard deviation.

14. The method of 12, further comprising:
inferring, by performing linear regression on outputs of a corresponding matrix-vector multiplication operation, programmed conductances of the analog crossbar;
computing a row-wise standard deviation \hat{σ}ᵢ; and
dividing an output (ωx)ᵢ by the row-wise standard deviation \hat{σ}ᵢ to derive a unit standard deviation.

15. An apparatus comprising:
a programming circuit;
an analog crossbar array, coupled to the programming circuit, and having an input and an output;
a digital to analog converter coupled to the input of the analog crossbar array;
an analog to digital converter coupled to the output of the analog crossbar array; and
a digital processing unit coupled to the analog to digital converter;
wherein:
the programming circuit is configured to program weights into the analog crossbar array;
the analog crossbar array is configured to perform two matrix vector multiplications with first and second analog inputs obtained from the digital to analog converter, based on the programmed weights; and
the digital processing unit is configured to computer a dot product of the outputs of the two matrix vector multiplications corresponding to the first and second inputs, obtained from the analog to digital converter.

16. The apparatus of claim 15, wherein the digital processing unit is further configured to:
determine a probability distribution corresponding to a kernel function; and
sample weights from the determined probability distribution corresponding to the given kernel function, wherein the programmed weights correspond to the sampled weights.
